(19) United States
(12) Patent Application Publication
(10) Pub. No.: US 2002/0008463 A1
(43) Pub. Date: Jan. 24, 2002

(54) Display device and module therefor

(76) Inventor: William R. Roach, Rocky Hill, NJ (US)

Correspondence Address: DANN DORFMAN HERRELL & SKILLMAN, SUITE 720, 1601 MARKET STREET, PHILADELPHIA, PA, 19103-2307, US

(21) Appl. No.: 09/876,588

(22) Filed: Jun. 7, 2001

Related U.S. Application Data
(60) Provisional application No. 60/213,568, filed on Jun. 22, 2000.

(51) Int. Cl. H01J 1/62

(52) U.S. Cl. 313/492

(57) ABSTRACT

A number of light-emitting fibers in side-by-side array comprise a display which may be employed alone or with other like displays. Each fiber includes a number of light-emitting elements disposed along an optical fiber, such as an electroluminescent material, e.g., an OLED material, disposed between hole injecting and electron injecting electrodes. Contacts to both the hole injecting and electron injecting electrodes are on the same surface of the fiber. A printed circuit board has plural parallel conductors that connect to respective contacts for the hole injecting and electron injecting electrodes on the light-emitting fibers, such as by solder, conductive adhesive and the like.

This Application claims the benefit of U.S. Provisional Application Ser. No. 60/213,568 filed Jun. 22, 2000.

The present invention relates to a display and, in particular, to a display and an electrical module therefor.

It has long been desired that electronic displays be made with larger screen sizes and also be very thin, ultimately reaching a configuration that may be hung on a wall. Inherent physical limitations preclude conventional cathode ray tubes, such as the color picture tubes and display tubes utilized in televisions, computer displays, monitors and the like, from achieving such desired result. While plasma displays have been proposed to satisfy such desire, the large glass vacuum envelope they require is both heavy and expensive, which is not desirable.

The entire display screen of plasma displays must be fabricated as a single unit and must reproduce many thousands of picture elements or “pixels.” Any significant defect that results in faulty pixels or in a non-uniform brightness across the screen, even if confined to a relatively small area, renders the entire screen defective. Such defects cannot be tested or detected until the entire screen is processed, and are either not susceptible of repair or are very expensive to repair, thereby substantially reducing the yield and increasing the cost of each satisfactory plasma display.

One attractive approach for producing a large, thin display screen is to provide an array of a large number of adjacent light-emitting fibers. An advantage of such light-emitting fiber display is that each fiber is relatively inexpensive and may be separately tested before assembly into a display. Because defective fibers are detected and discarded before assembly into a display, the yield of a display which is made from known good light-emitting fibers is increased and the cost thereof is reduced. One such fiber display is described in published PCT Application WO 00/51192 entitled “DISPLAY DEVICE.”

With regard to such fiber-based displays, it is desirable that the light-emitting fibers therefor be connected reliably and inexpensively, e.g., in a way that provides suitable performance, facilitates assembly of fibers into a display, and/or reduces cost. This is particularly of interest because two connections must be made to each pixel via conductors referred to as “select lines” and data lines” which typically lie in substantially orthogonal directions, one in the direction of the side-by-side fibers and the other transversely with respect to the side-by-side light-emitting fibers.

In the arrangement of WO 00/51192, a large multi-layer circuit substrate or printed circuit board 210 (FIGS. 3 and 4) is substantially the same size as the viewing screen of the display 10 and is connected to the light-emitting fibers 100 by conductive bump connections 232. The fabrication of such large substrate is likely to be complex and possibly costly, as may be the alignment and connection of such substrate to the fibers. In addition, a large one-piece circuit substrate departs from some of the benefits of a modular display as set forth therein.

WO 00/51192 also describes a flexible circuit board 360 suitable for a display module 310 (FIGS. 8, 9A and 9B) to facilitate assembly of flexible circuit boards into modules for a display. Electronic circuits employing a flexible printed circuit substrate or a combination of a rigid printed circuit board and a flexible cable tend to be more expensive than conventional rigid circuit boards.

Accordingly, there is a need for an improved arrangement for connecting light-emitting fibers, and desirably one that is easily aligned and low in cost

To this end, the display of the present invention comprises a plurality of fibers disposed in side-by-side array and each having a plurality of light-emitting elements disposed on a first surface thereof and a length, each light-emitting element having first and second electrodes, wherein the first electrodes are electrically connected to a first contact on the first surface proximate an end of each the fiber and wherein the respective second electrodes are connected to respective second contacts proximate the corresponding light-emitting element, wherein the respective first contacts of the plurality of side-by-side fibers are at different positions with respect to each other relative to the lengths of the fibers. A circuit board having first and second pluralities of elongated conductors disposed in respective substantially parallel side-by-side arrangement is disposed proximal the plurality of side-by-side fibers with the first and second pluralities of elongated electrical conductors disposed substantially transverse to the lengths of the fibers, wherein each of the first plurality of elongated conductors is electrically connected to the first contact of a predetermined one of the plurality of fibers and wherein each of the second elongated conductors is electrically connected to the second contacts of corresponding light-emitting elements of each of the plurality of fibers.

### BRIEF DESCRIPTION OF THE DRAWING

The detailed description of the preferred embodiments of the present invention will be more easily and better understood when read in conjunction with the FIGURES of the Drawing which include:

FIG. 1 is a perspective view schematic diagram of an exemplary embodiment of a display including a circuit board and light-emitting fibers and illustrating the arrangement thereof in accordance with the invention;

FIGS. 2A, 2B and 2C are a bottom view, a side view and an end view schematic diagram, respectively, of the exemplary embodiment of a display of FIG. 1;

FIGS. 3A and 3B are schematic diagrams illustrating alternative exemplary arrangements of a light-emitting fiber including the plurality of lightemitting elements disposed on one surface thereof, useful in the display of FIGS. 1 and 2A-2C;

FIGS. 4A through 4C are schematic diagrams illustrating steps in the assembly of an exemplary display of a light-emitting fiber display including the electronic circuit of FIG. 1;

FIG. 5 is a schematic diagram of an embodiment of a display employing a compressible spacer in accordance with the invention;

FIG. 6 is a plan view schematic diagram of an exemplary display in accordance with the invention with the circuit module cut away to show certain connections therein;

FIG. 7 is a plan view schematic diagram of an alternative arrangement of the display of FIG. 6 showing certain alternative connections thereof;

FIG. 8 is a plan view schematic diagram of an alternative arrangement of the display of FIG. 7;

FIG. 9 is a rear plan view schematic diagram of an exemplary light-emitting display including a plurality of the displays of FIG. 1;

FIGS. 10A and 10B are a side view and an end view schematic diagram, respectively, of the exemplary light-emitting display of FIG. 9; and

FIGS. 11A and 11B are cross-sectional views taken along cross-section lines 11A-11A and 11B-11B, respectively, in FIG. 6.

In the Drawing, where an element or feature is shown in more than one drawing figure, the same alphanumeric designation may be used to designate such element or feature in each figure, and where a closely related or modified element is shown in a figure, the same alphanumerical designation primed may be used to designate the modified element or feature. It is noted that, according to common practice, the various features of the drawing are not to scale, and the dimensions of the various features are arbitrarily expanded or reduced for clarity.

### DESCRIPTION OF THE PREFERRED EMBODIMENT

A plurality of light-emitting fibers 200, i.e. fibers each having a plurality of light-emitting elements disposed along its length, are arrayed in side-by-side array, preferably being substantially contiguous, and are connected to appropriate electrical driver circuits for selectively and controllably energizing each light-emitting element or picture element (pixel) to produce a light-emitting display 10 for displaying an image or information. Image and/or information are used interchangeably with respect to what is displayed on a display device, and are intended to encompass any and all of the wide variety of displays that a user may desire, including, but not limited to, visual images and pictures, whether still or moving, whether generated by a camera, computer or any other source, whether true, representative or abstract or arbitrary, whether or not including symbols or characters such as alphanumeric characters or mathematical notations, whether displayed in black and white, monochrome, polychrome or color.

A light-emitting fiber 200 is fabricated, for example, on a fiber of an optically transmissive material, such as glass, borosilicate glass, soda-lime glass, quartz, sapphire, plastic, polymethyl-methacrylate (PMMA), polycarbonate, acrylic, Mylar, polyester, polyimide or other suitable material, to have along its length on one of its surfaces a plurality of light-emitting elements or picture elements (pixels) 280. Lightemitting elements 280 include an electro-luminescent material, preferably an Organic Light-Emitting Diode (OLED) material, disposed between suitable electrodes. Each light-emitting element or OLED “stack” includes a hole-injecting electrode, one or more layers of one or more OLED materials and an electron-injecting electrode, and is independently operable to produce one pixel of the image or information to be displayed. In a color display, three physical pixel elements may each produce one of three color sub-pixels that emit light of three different colors that together produce one color pixel of a color image.

Each light-emitting fiber includes a conductor along its length for applying select signals to each of the light-emitting elements disposed along the length of that fiber. Each light-emitting fiber also includes a plurality of contacts along its length, one contact for each light-emitting element, to which conductors providing pixel data signals are connected. Such data signal conductors lie transverse to the length direction of the light-emitting fibers for interconnecting such fibers in an array of a light-emitting display, as described herein.

Thus, suitable electrical connections can be made to couple the select signal and the data signal to respective electrodes of each light-emitting element for controllably and selectively energizing each light-emitting element to produce the pixels of an image to be displayed by a light-emitting display including a plurality of light-emitting fibers in parallel side-by-side array. These connections are made to the surface of the light-emitting fibers on which the light-emitting elements are formed, and the light emitted thereby passes through the optical fiber away from the lightemitting elements to be observed by a viewer of such display.

It is noted that because the light-emitting fibers may be of any desired length, and because any desired number of such fibers may arrayed side-by-side, a thin panel display of virtually any desired size (height and width) may be assembled utilizing the present invention.

An exemplary optical fiber is typically about 0.25 mm (about 0.010 inch) wide, and has light-emitting elements disposed along its length on a pitch of about 0.75 mm (about 30 mils). Where the light-emitting fibers are utilized in a color display, light-emitting elements emitting three different colors of light, such as red (R), green (G) and blue (B), are utilized. The three different color light-emitting elements are arranged to be in adjacent sets of R, G, B elements, each set providing a color pixel. Such arrangement of light-emitting elements may be provided by sequencing R, G and B OLED materials along the length of each light-emitting fiber or may be provided by placing fibers of different colors side-by-side in an R-G-B sequence, i.e. a red-emitting fiber next to a green-emitting fiber next to a blue-emitting fiber, and so forth. Typical light-emitting fibers are described, for example, in published PCT Application WO 00/51192 entitled “DISPLAY DEVICE” and in U.S. patent application Ser. No. 09/691,882 entitled “LIGHT-EMITTING FIBER, AND METHOD FOR MAKING SAME” filed Oct. 19, 2000.

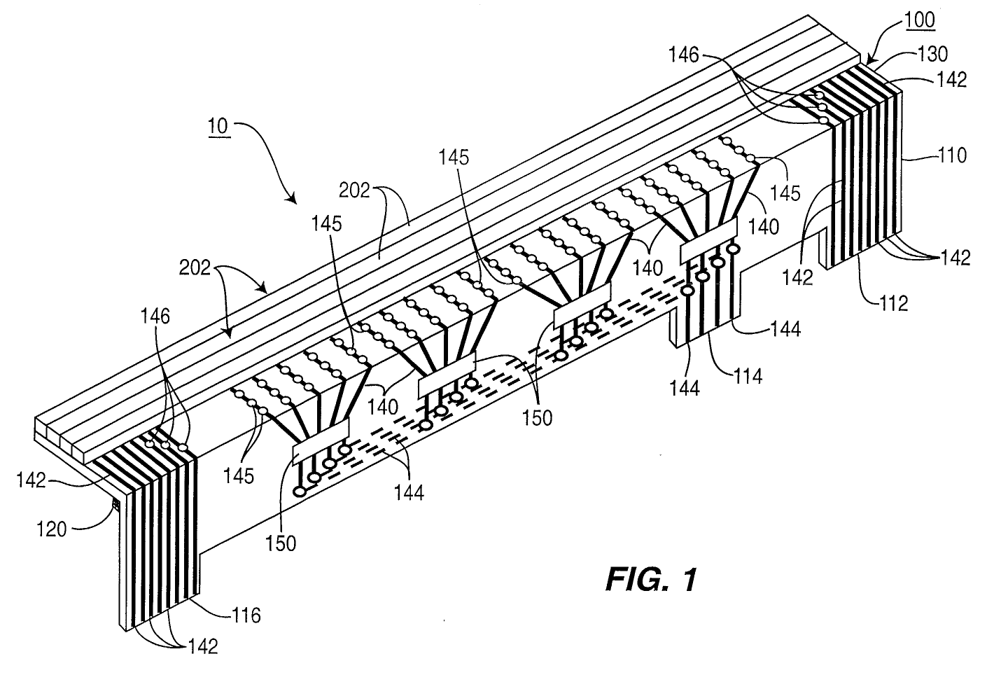

FIG. 1 is a perspective view schematic diagram of an exemplary embodiment of a display module 10 including a circuit board 100 and light-emitting fibers 200 and illustrating the arrangement thereof in accordance with the invention. Circuit board 100 includes a first portion 110 and a second portion 130 that are positioned at about a right angle to each other, although a greater or lesser angle could be utilized. First portion 110 of circuit board 100 has edge connections 112, 114, 116 at which printed conductors 142, 144 are arrayed for being engaged by a conventional edge connector (not shown) through which electrical signals are provided to and received from the electronic circuits on circuit board 100. Electronic devices 150, such as integrated circuits, hybrid circuits electronic circuit modules and the like, are mounted to first portion 110 for operating on the signals received via edge connections 112, 114, 116 and for providing drive signals, such as select signals and/or data signals, to light-emitting fibers 200.

Second portion 130 of circuit board 100 includes electrical conductors 140, 142 on one side thereof through which signals, e.g., data signals via conductors 140 from electronic devices 150 and select signals via conductors 142 from edge connections 112, 116, are applied to plural light-emitting fibers 200 that are arrayed side-by-side. Conductors 144 couple drive signals from edge connection 114 to electronic device 150. The surface 202 of light-emitting fibers 200 from which light is emitted faces away from second portion 130 of circuit board 100. For example, conductive “dots” 145, such as small drops of solder or electrically conductive epoxy may be applied to the contacts of the light-emitting elements of fibers 200, or to conductors formed across several fibers in a direction transverse to the length thereof, and the second portion 130 of circuit board 100 positioned thereagainst for connecting ones of conductors 140 on second portion 130 to the contacts of fibers 200. Fibers 200 include a contact at one or both ends thereof for receiving a second signal or select signal, and conductors 142 on circuit board 100 connect thereto by like conductive dots 146. Thus, signals from electronic devices 150 are applied to ones of the light-emitting elements of side-by-side arrayed fibers 200 to display information. Circuit board 100 together with the side-by-side array of light-emitting fibers 200 provide a light-emitting display or display module 10.

First portion 110 and second portion 130 are maintained in the desired relative positions by a fillet of epoxy 120 along the inside comer formed where the two portions 110, 130 meet. The structure thus formed is in effect a beam having an Lshaped cross-section and so is quite rigid, especially in the longer dimension, thereby to provide substantial support to the light-emitting fibers 200. Display module 10 is also advantageous because circuit board 100 supports light-emitting fibers 200 so as to facilitate the placement of fibers 200 as modules 10 in close proximity on a common faceplate, thereby to provide a light-emitting display comprising a plurality of light-emitting display modules 10. Desirably, such arrangement may be utilized to provide a display that is economical, reliable and rugged.

Electronic drive circuit 150 is, for example, an integrated circuit, hybrid circuit, microelectronic circuit or other electronic device that produces drive signals, such as data drive signals and/or select drive signals, to be applied to the data and/or select electrodes of the light-emitting elements of the fibers 200. Patterned conductors 140, 142 are preferably in substantially parallel spaced-apart relationship at the end of second portion 130 of circuit substrate 100 distal driver circuit 150 and proximal fibers 200 to which they are attached.

More particularly, patterned conductors 140, 142 are preferably substantially parallel and spaced apart at like pitch to the spaced-apart corresponding contacts of fibers 200, thereby providing conductors 140, 142 that facilitate a direct and simple interconnection between ones of the patterned conductors 140, 142 of electronic circuit 100 and the corresponding contacts of fibers 200.

Circuit board 100 can be tested, either fully or to any desired degree, prior to assembly to light-emitting fibers 200. Thus, any inoperative function or out of specification condition can be identified and rectified at a lower assembly level, before circuit board 100 is assembled to any light-emitting fibers 200 and the cost of troubleshooting and repair, or of scrapping the item, is much greater.

An exemplary circuit board 100 was made of 0.060 inch (about 1.5 mm) thick fiberglass/epoxy material (e.g., FR4) with 0.001 inch (about 0.025 mm) thick copper conductors that were solder tinned. The conductors were 0.010 inch (about 0.25 mm) wide and separated by 0.18 inch (about 4.5 mm) wide spaces. A 90° V-shaped groove was made in the circuit board, but not severing the printed circuit conductors thereon, and the circuit board was bent 90° and secured with a five-minute curing commercial epoxy without damage to the bent copper conductors, as determined by visual inspection and electrical continuity testing.

It is noted that the second portion 130 of circuit board 100 preferably includes only the conductors 140, 142 that will be attached to contacts on light-emitting fibers 200 by electrically-conductive adhesive or low-temperature solder, i.e. the data signal conductors and the select signal conductors, and so the second portion 130 of circuit board 100 may have only a “single-sided” conductor pattern. The first portion 110 of circuit board 100 may have a “single-sided” or a “double-sided” conductor pattern as is convenient. Conductors 118 between edge connections 114, for example, and electronic devices 150 may include connections between conductors on the two opposing surfaces of circuit board 100 for providing cross overs and the like, as may be necessary or convenient. Conventional edge connectors are available for connecting to either “single-sided” or “double-sided” conductor patterns.

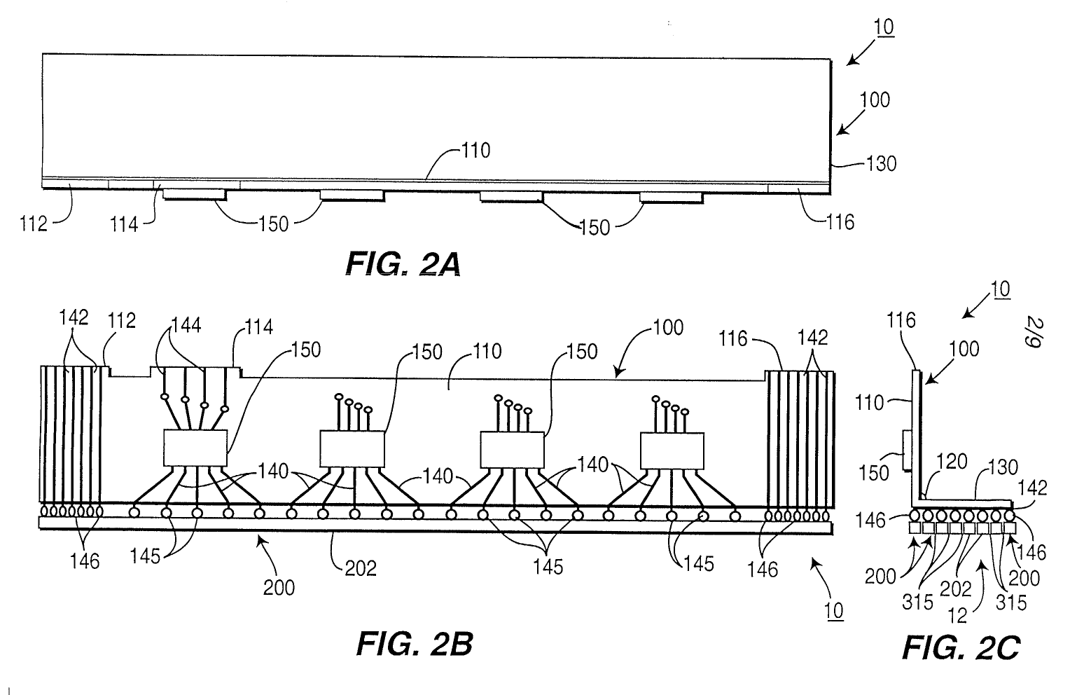

FIGS. 2A, 2B and 2C are a bottom view, a side view and an end view schematic diagram, respectively, of the exemplary embodiment of a display module 10 according to FIG. 1. Display module 10 comprises a bent electronic circuit board 100 having a plurality of electronic devices 150 on the first portion 110 thereof and having a plurality of light-emitting fibers 200 attached to the second portion 130 thereof. The surface 202 of light-emitting fibers 200 from which light is emitted faces away from second portion 130 and together provide a viewing surface 12 on which a viewer may observe the information displayed. The plurality of light-emitting fibers 200 are attached to the second portion 130 by a plurality of conductive dots 145, 146. Conductive dots 145, 146 connect ones of data bus conductors 140 and select bus conductors 142 of circuit board 100 to corresponding ones of the contacts of plural fibers 200.

Display module 10 includes plural light-emitting fibers 200 arrayed in parallel side-by-side arrangement and an electronic circuit board 100 coupled thereto for providing electrical drive signals, such as select signals and/or data signals, for the light-emitting elements thereon. The array of side-by-side fibers 200 may include compressible spacers 315 between ones of fibers 200, as described below.

This arrangement advantageously provides for convenient positioning of circuit boards 100 in modules 10 with tolerance being important only in the direction transverse to conductors 140, 142. In addition, adjacent modules 10 do not interfere, even if certain components of a particular module such as devices 150 extend beyond the edges of that module 10.

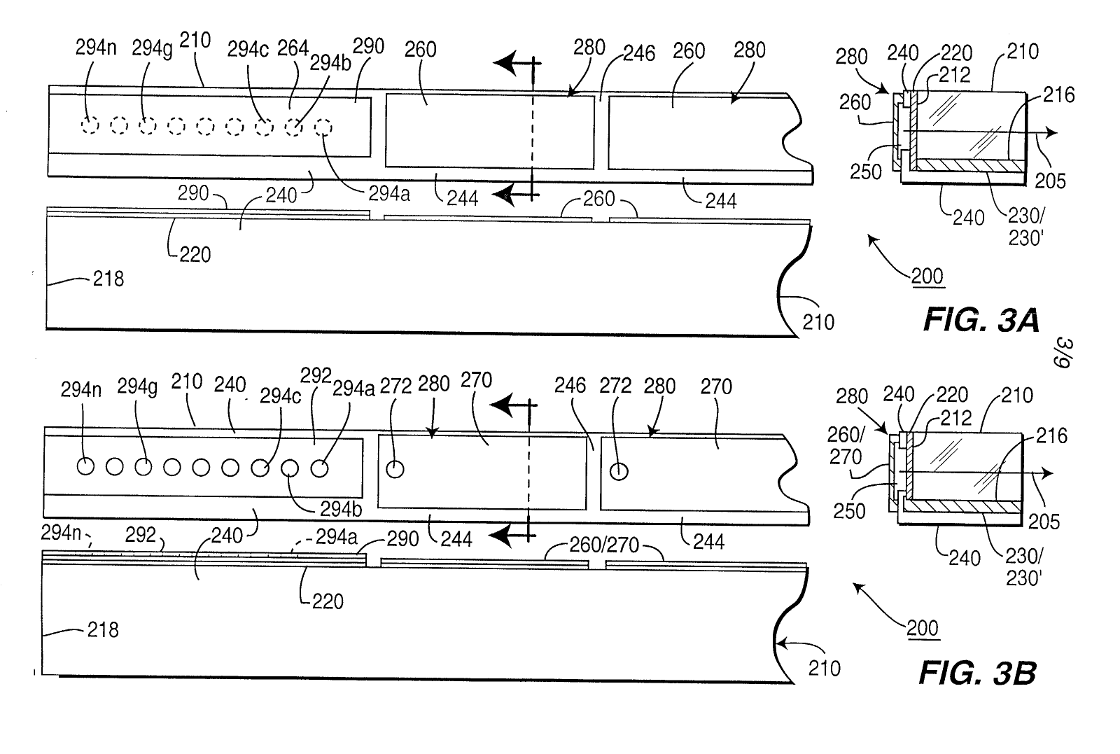

FIGS. 3A and 3B are schematic diagrams illustrating alternative exemplary arrangements of light-emitting fiber 200 including the plurality of lightemitting elements 280 disposed on one surface thereof. Only a portion of fiber 210 and/or light-emitting fiber 200 is shown in FIGS. 3A-3B which each include a top view, a side view and an end view or cross-sectional view. Fiber 210 or other elongated member of an optically transmissive material has a thin layer of optically transmissive, electrically-conductive material 220 on the top surface 212 thereof. Conductive layer 220, such as indium tin oxide (ITO), tin oxide, zinc oxide, a noble metal, combinations thereof, or another transparent hole-injecting material, serves as the hole injecting electrode of a later completed OLED light-emitting element or stack 280.

An electrically conductive bus 230, preferably of a highly conductive metal such as aluminum, copper, gold, chromium/gold (Cr Au) or silver, is deposited on or attached to one side 216 of optical fiber 210 and slightly overlaps the ITO 220 either on top surface 212 or on side surface 216. Conductive bus 230 makes electrical contact to ITO layer 220 for providing an electrical connection of relatively high electrical conductivity between the portion of hole injecting electrode 220 associated with each light-emitting element 280 and an input contact 290 at one or both ends 218 of optical fiber 210.

Particularly in large displays, the lengths of conductor 230 may become long and the resistance of a thin-film or other deposited conductor 230 may be higher than desired. Conductor 230 may be made thicker than the thicknesses obtainable by vacuum deposition of metals such as by attaching thin strips 230′ of metal foil (e.g., 25-50 μm thick) along the length of fiber 210 and connected at intervals or continuously to ITO layer 220 by a spot or line of electrically-conductive epoxy or adhesive. Such strips 230 may be of aluminum, copper, silver, gold or other suitable metal, and may be in place of or in addition to the deposited strips 230, and may be embossed so as to be compressible. Where a metal foil strip 230 is employed in addition to a deposited conductor 230, the metal foil strip may simply be compressed against an exposed surface of deposited conductor 230 (i.e. a region not covered by insulator 240) by the (insulated) side of an adjacent fiber 200.

Insulating layer 240 covers both edges of ITO layer 220 on the top 212 of fiber 210 as well as conductor 230 along side 216 of fiber 210. Insulating layer 240 is patterned on the top surface 212 of fiber 210 to define a plurality of openings in the desired shape of the light-emitting elements 280. Preferably, because the area of each of the light-emitting elements 280 is desirably as large as possible to maximize the light produced and therefore the brightness of the display in which light-emitting fiber 200 is employed, rectangular elements 280 having opposing edges close to the edges of fiber 210 are desirable. Thus the width of the portion 244 of insulation layer 240 that is disposed along the edges of fiber 210 for defining two edges of openings 242 are typically as narrow as tolerances and processing allow, so long as sufficient width is present to enable the light-emitting material 250 that is later deposited to be fully enclosed or encapsulated. Similarly, the transverse portion 246 of insulation layer 240 defining the space between adjacent openings is made narrow for increasing the area of the openings relative to the area of top surface 212 consistent with tolerances and the width thereof appropriate for insulation between adjacent elements 280 and contact with an upper electrode contact 270 later applied.

Insulation layer 240, which prevents or reduces moisture and other undesirable material from reaching the OLED light-emitting material 250 while not interfering with the making of electrical connection thereto, furthers achieving long life and high performance of the OLED light-emitting elements 280. Suitable moisture barrier materials include silicon nitride, silicon dioxide, silicon oxynitride, silicon carbide, diamond-like carbon, and phosphorus-silicate glass, and are typically applied through a mechanical mask.

Alternatively, insulation layer 240 may be formed of an organic layer, such as a layer of a photoresist material. The photoresist may be deposited by dip coating and/or spraying or other suitable method and then be exposed and developed, and then partially removed to form openings exposing ITO electrode layer 220. The organic layer may also be selectively deposited, such as by screen printing or ink jet printing, in the pattern of layer 240. Another suitable type of material for insulation layer 240 is an epoxy that is selectively deposited in the desired pattern and is then cured by exposure to ultra-violet light. In each case, however, insulating layer 240 remains in place during the deposition of the OLED stack 250 and the electrode layer 260 and contact layer 270, and so must be processed to be fully compatible with the OLED and electrode materials and the processing thereof.

It is desirable that conductor 230 wrap around from the side 216 of fiber 210 to the top 212 thereof so as to provide a contact 290 that overlies the portion of ITO layer 220 near end 218 of fiber 210, or, alternatively, that ITO layer 220 overlap conductor 230. Electrical bus 230, which couples a drive signal to the ITO electrodes 220 of each light-emitting element 280 along the length of optical fiber 210, is preferably covered by insulation layer 240 for providing electrical insulation thereof, particularly when a plurality of fibers 200 are in side-by-side array, as in a display 10.

Layer 250 of OLED material is deposited on ITO layer 220 and insulation layer 240. In the simplest form for fabrication, OLED layer 250 may be continuous, or it may preferably be deposited as segments 240 each overlying an opening in insulation layer 240. OLED layer or stack 250 does not overlie region 290 thereby leaving the end of ITO layer 220 exposed. OLED stack 250 typically includes several different layers of material, each typically having a thickness of about 500 Å, or more or less.

A segmented layer 260 of electron injecting material is deposited on OLED stack 250, and a relatively durable conductive segmented contact layer 270 is similarly deposited onto segmented electrode layer 260 with the segments of layers 260 and 270 in registration, as illustrated in FIGS. 3A and 3B, although the segments of layer 270 are typically slightly larger than those of layer 260. The segments of layer 270 extend slightly beyond the edges of OLED layer 250 so as to completely overlie the OLED layer 250 and to contact insulation layer 240 completely surrounding and isolating OLED layer 240, thereby to retard or prevent moisture and other contaminants from reaching OLED material 250.

Each stack of hole-injecting layer 220, light-emitting material 250 and electron-injecting material 260 provides a light-emitting element 280 to which electrical control signals are applied via conductors 220/230 and 260/270 for causing light-emitting elements 280 to emit light. The electrical control signals applied via conductors 220/230 are usually referred to as “select signals” where plural light-emitting fibers 200 are disposed side-by-side in a display, and the electrical control signals applied via conductors 260/270 are referred to as “data signals” because their amplitude or duration is controlled to affect the amount of light emitted by light-emitting elements 280. Where plural fibers 200 are, for example, disposed horizontally in a display, the electrical control signals applied via conductors 220/230 are usually referred to as “row selection” signals, and the electrical control signals applied via conductors 260/270 are referred to as “column data” signals.

The breaks between adjacent ones of the segments contact layer 270 overlie transverse portions 246 of insulation layer 240 separating adjacent openings therein, so that a substantial part of each transverse portion 246 is covered by contact segment 270 for defining a contact 272 by which electrical connection can preferably be made to the electron-injecting electrode 260 of light-emitting OLED elements 280. The segments of OLED layer 250 and of electron injecting/contact layers 260, 270 are thus of like pitch along the length of optical fiber 210, but segments of layer 270 are preferably offset so that each segment thereof 270 overlies one transverse portion 246 and provides a contact 272 to electrode 260.

Top electrode 260 may be a layer of magnesium, magnesium/silver, calcium, calcium/aluminum, lithium fluoride or lithium fluoride/aluminum, or any other stable electron injector. Contact layer 270 may be aluminum, gold, chromium/gold (Cr Au) or copper, for example, or any other durable high-conductivity material. Top electrodes 260 and contacts 270 are in one-to-one correspondence with one another and with a portion of ITO layer 220, separated by a light-emitting material layer 250, along the length of optical fiber 210. It is noted that contacts or connection sites 272, 294a-294g may simply be locations designated such on conductor layer 270 as shown in FIG. 3A or may be sites at which additional thickness of the conductive material of layer 270 or other compatible conductive material is build up for providing a more durable contact, as shown in FIG. 3B.

Contacts 272 are durable and provide a durable contact structure to which conductors providing pixel data signals are connected, which data signal conductors (not shown) lie transverse to the length direction of light-emitting fibers 200 in a display. Because insulating layer 240 lies under the contact 272 portion of contact layer 270, the connecting of such transversely oriented data signal conductors to such contact 272 cannot cause a short circuit between the hole injecting electrode layer 220 and the electron injecting electrode 250 of any light-emitting element 280. Even if a portion of OLED layer 250 were to underlie contact 272, it would not be a portion of OLED layer 250 that produces light and so any damage thereto would not affect operation of any light-emitting element 280.

Preferably, the deposition of contact layer 270 also produces a contact region 290 and/or contacts 294a-294g at the end 218 of optical fiber 210 connecting directly to ITO electrode 220 and electrical bus 230 at the end 218 of optical fiber 210 to provide a durable contact structure to which conductors providing row select signals are connected. Also preferably, insulation layer 240, 292 defines openings 294a-294n at one or both ends 218 of fiber 210 at which ends of contact layer 290 on ITO layer 220 is exposed for later making electrical connection to the hole-injecting electrode 220 of light-emitting elements 280 and to electrical conductor 230 providing a relatively high conductivity connection thereto. Alternatively, a layer 270 of high-conductivity material may be deposited through openings 294a-294g in insulation layer 292 to provide a high-conductivity connection to longitudinal conductor 230.

Thus, suitable electrical connections can be made to couple the select signal and the data signal to respective electrodes 220 and 260 of each light-emitting element 280 for controllably and selectively energizing each light-emitting element 280 to produce the pixels of an image to be displayed by a display including a plurality of light-emitting fibers 200 in parallel side-by-side array. These connections are made to the surface of the light-emitting fibers 200 on which the light-emitting elements are formed, and the light emitted thereby (indicated by arrow 205) passes through the optical fiber 210 away from the light-emitting elements 280 to be observed by a viewer of such display. It is noted that because light-emitting fibers 200 may be of any desired length, and because any desired number of such fibers 200 may arrayed side-by-side, a thin panel display of virtually any desired size (height and width) may be assembled utilizing the present invention.

Light emitted by light-emitting element 280 passes through optical fiber 210 to be observed by a viewer of the display including light-emitting fiber 200, as is indicated by arrow 205. While the light is generated in OLED material 250, it passes through the ITO or other thin material of electrode 220 in the direction indicated by arrow 205. The presence of top electrode 260 and/or contact layer 270 overlying OLED layer 250 desirably reflects light from OLED material 250 and so tends to increase the light output along the direction of arrow 205.

Fiber 210 is generally of rectangular cross-section having an aspect ratio of thickness to width typically ranging between about 1:1 and 10:1. If fiber 210 is about 0.25 mm (about 0.010 inch) wide, i.e. on the surface having light-emitting elements 280 thereon, it is typically in the range of about 0.25-2.5 mm (about 0.010-0.1 inch) thick, and may typically be about 1.25 mm (about 0.05 inch) thick. If fiber 210 is about 0.38 mm (about 0.015 inch) wide, it is preferably in the range of about 1.5-3.8 mm (about 0.060-0.15 inch) thick, and may typically be about 1.9 mm (about 0.075 inch) thick.

Where light-emitting fiber 200 is utilized in a color display, light-emitting elements 280 emitting three different colors of light, such as red (R), green (G) and blue (B), are utilized. The three different color light-emitting elements are arranged to be in adjacent sets of R-G-B elements, each set providing a color pixel. Such arrangement of R-G-B light-emitting elements may be provided by sequencing R, G and B OLED materials 250 along the length of each light-emitting fiber 200 or may be provided by placing fibers 200 of different colors side-by-side in an R-G-B sequence, i.e. a red-emitting fiber next to a green-emitting fiber next to a blue-emitting fiber and so forth. The red-emitting fibers, green-emitting fibers, and blue-emitting fibers may be fabricated on ribbons or fibers 200 that are each tinted to the desired color or may employ different light-emitting materials that respectively emit the desired color.

In either case, it is preferred that patterned passivating material 240, 292 be deposited onto the plurality of fibers 200 in areas not containing contacts 270, 272, 294, 294a-294n, to slow the permeation of moisture and oxygen to the OLED material of the light-emitting elements of fibers 200, and to reduce the likelihood of short circuits occurring between closely spaced ones of contacts 270, 272, 294, 294a-294n.

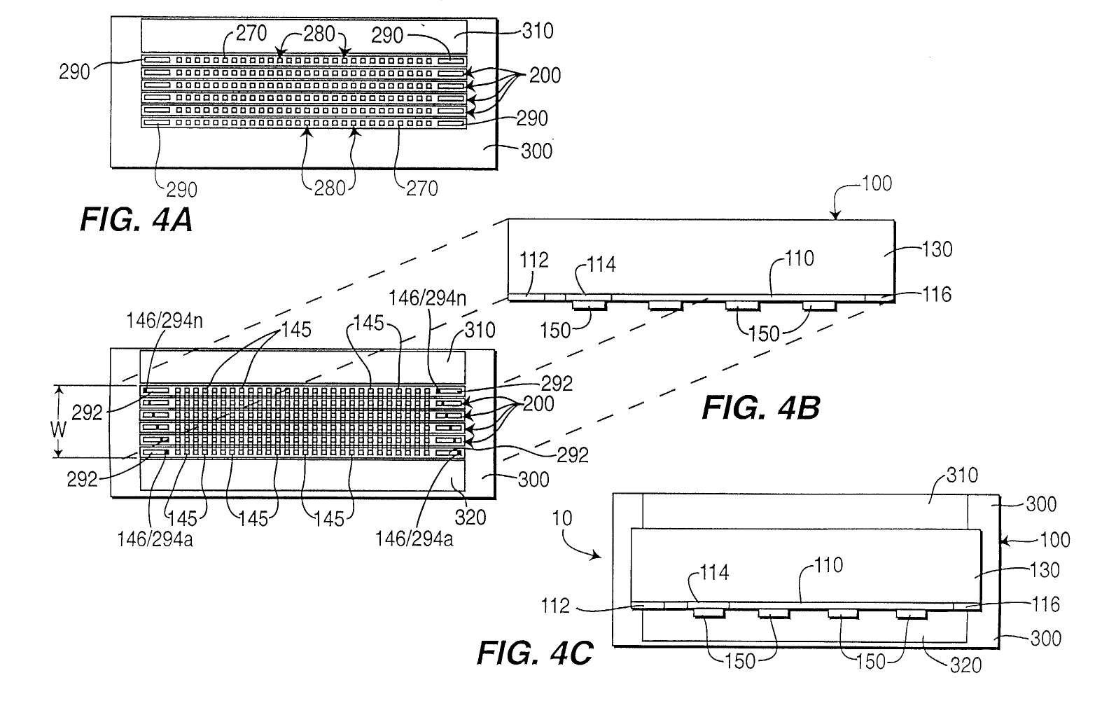

FIGS. 4A through 4C are schematic diagrams illustrating the steps in the assembly of an exemplary display module 10 of a light-emitting fiber display including the exemplary electronic circuit 100 of FIG. 1. A flat plate 300 of length exceeding the length of light-emitting fibers 200 and of width exceeding that of the plurality of fibers 200 to be assembled is provided, as shown in FIG. 4A. Flat plate 300 includes, for example, a fixed stop plate 310 that is either attached to or integral with plate 300. A plurality of light-emitting fibers 200 are placed side-by-side on flat plate 300 adjacent to fixed stop plate 310 with their respective surfaces 202 from which light is emitted against plate 300 and with their respective surfaces having light-emitting elements 280 thereon facing away from plate 300. Each light-emitting element 280 has an exposed data contact 270, 272 at which data signals are to be applied and preferably has a select contact 290, 294a-294n at one or both ends thereof.

A clamp plate 320 is placed against fibers 200 as shown in FIG. 4B to press them against fixed plate 310. The plurality of fibers are placed on flat plate 300 with their respective ends substantially aligned and, in addition, clamping plates 330 (not shown) may be placed at the respective ends of fibers 200 to maintain the desired alignment. Thus, light-emitting fibers 200 are firmly held in substantially the positions in which they will be disposed in the final assembly of a display module 10 of width W. Alternatively, deposition of the OLED material(s) 250 could be performed after fibers 210 are clamped to plate 300.

Next, small “dots” or spots 145 of electrically conductive adhesive or of low-temperature solder are deposited on each of the data contacts 270, 272, and small “dots” or spots 146 of the same one of electrically conductive adhesive or of low-temperature solder are deposited on each of the select contacts 294a-294n, also as shown in FIG. 4B. Preferably the dots 145 are on areas thereof that do not overlie the active or light-producing area of the OLED material of the light-emitting elements 280 of fibers 200 and preferably dots 146 are on the contact areas 294a-294n such as defined by openings in an insulating layer 292. The select bus contacts 294 may be at one or both ends of fibers 200 and, in such case, conductive dots 146 may be deposited on these select bus contacts 294 at one or both ends of fibers 200 as well.

Next, printed circuit board 100 is placed over the plurality of side-by-side light-emitting fibers 200 with its data bus conductors 140 aligned along corresponding ones of data contacts 270, 272 which are disposed transversely across light-emitting fibers 200 and with its select bus conductors 142 aligned with ones of select contacts 294a-294n, as shown in FIG. 4C. Circuit board 100 is moved toward fibers 200 until conductive dots 145, 146 are in position to form electrical connections between the respective data bus conductors 140 and select bus conductors 142 of circuit board 100 and the corresponding data contacts 272 and 294a-294n, respectively, of fibers 200.

Connections 145, 146 may be completed by heating, laser heating, passage of time for curing at ambient or elevated temperature, and/or exposure to ultraviolet (UV), as is appropriate to the material utilized for dots 145, 146. For example, where dots 145, 146 are of solder, heat is applied to melt the solder dots 145, 146 to form permanent solder connections. Where dots 145, 146 are of electrically-conductive adhesive, suitable temperature for tacking and/or curing the adhesive is applied.

After conductive adhesive dots 145, 146 are cured or the solder dots 145, 146 are reflowed to provide the desired electrical connections between circuit board 100 and the plurality of light-emitting fibers 200, clamp 320 is removed to release circuit board 100 and the plurality of light-emitting fibers 200 attached thereto by conductive dots 145, 146 thereby to comprise display module 10, as shown in FIGS. 2A, 2B and 2C, which is then removed from flat plate 300.

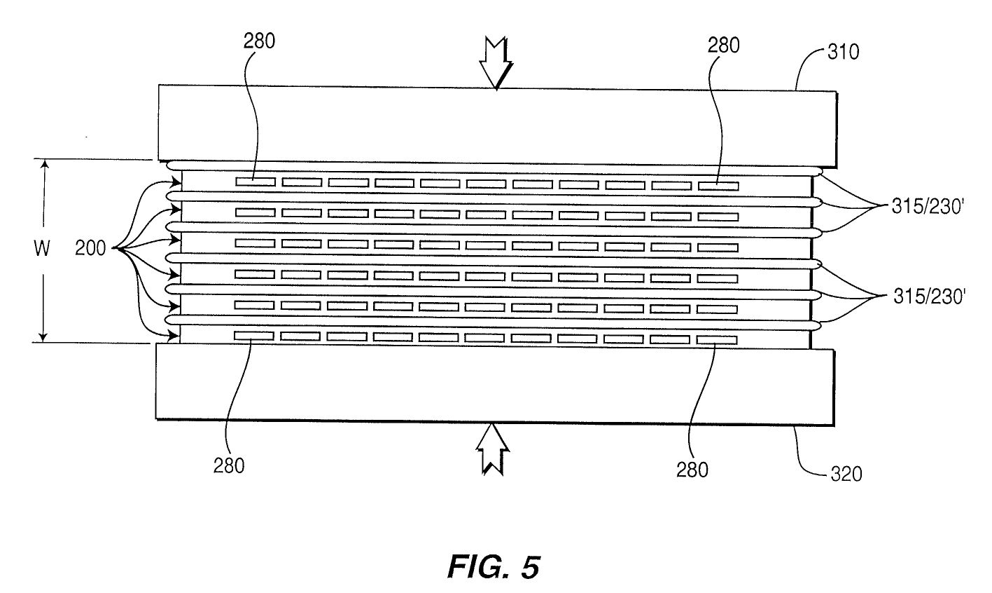

FIG. 5 is a schematic diagram of an embodiment of a display or display module 10 employing a compressible spacer 230′, 315 in accordance with the invention. Because each of fibers 200 has a width that is subject to tolerance, display 10 also has a width W that is subject to tolerance. Such tolerance may be due to tolerance of the width of fibers 210 and the layers of conductor 230 and insulator 240 thereon as well as other factors including varying intimacy of physical contact between adjacent fibers 200. Compressible spacer 230′ and/or 315 is employed between adjacent ones of fibers 200 to allow the plurality of fibers 200 to be compressed in width to a desired overall width dimension W as indicated in FIG. 4B. As a result, each module 10 is of width W to within a desired tolerance which can be less than the tolerance that could occur if the tolerances of individual fibers 200 were to accumulate, and so the array of fibers 200 will better align with circuit board 100.

For example, a module 10 including 120 fibers 200 each being about 0.25 mm (about 10 mils or 0.010 inch) wide would be about 30.05 mm (about 1.20 inch) wide. To maintain a width W to within a range of about 30.01-30.06 mm (about 1.185-1.205 inches), the width of each fiber 200 would have to be controlled to within about ±0.5%. Compressible spacer 230′, 315 may be an embossed or corrugated material that takes a permanent set when compressed or may be a soft material that squeezes out under compression. Two exemplary spacers 230′ and 315 are contemplated, and may be used as alternatives or in combination.

Electrically conductive spacer 230′ is an embossed thin metal foil, such as a copper, aluminum or gold foil, for example, of about 12 μm (about 0.5 mil) thickness that is embossed to have about 25 μm (about 1 mil) thickness, that either replaces deposited metal conductor 230 or is contiguous thereto along the length of fiber 200, i.e. in the space between two adjacent ones of fibers 200. Alternatively, where deposited conductor 230 is utilized, insulating compressible spacers 315 may be utilized. Insulating spacer 315 is an embossed thin plastic strip, such as Mylar, PVC or other suitable plastic, for example, of like dimension to that described above for spacer 230′. Thinner compressible spacers, such as spacers about 6 μm (about ¼ mil) thick, are also desirable.

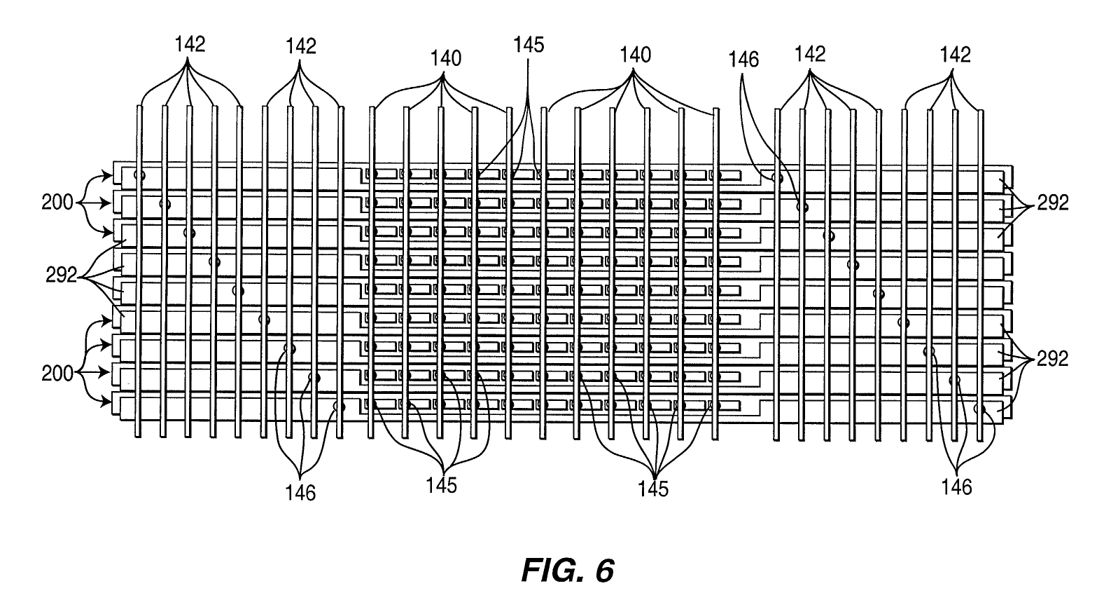

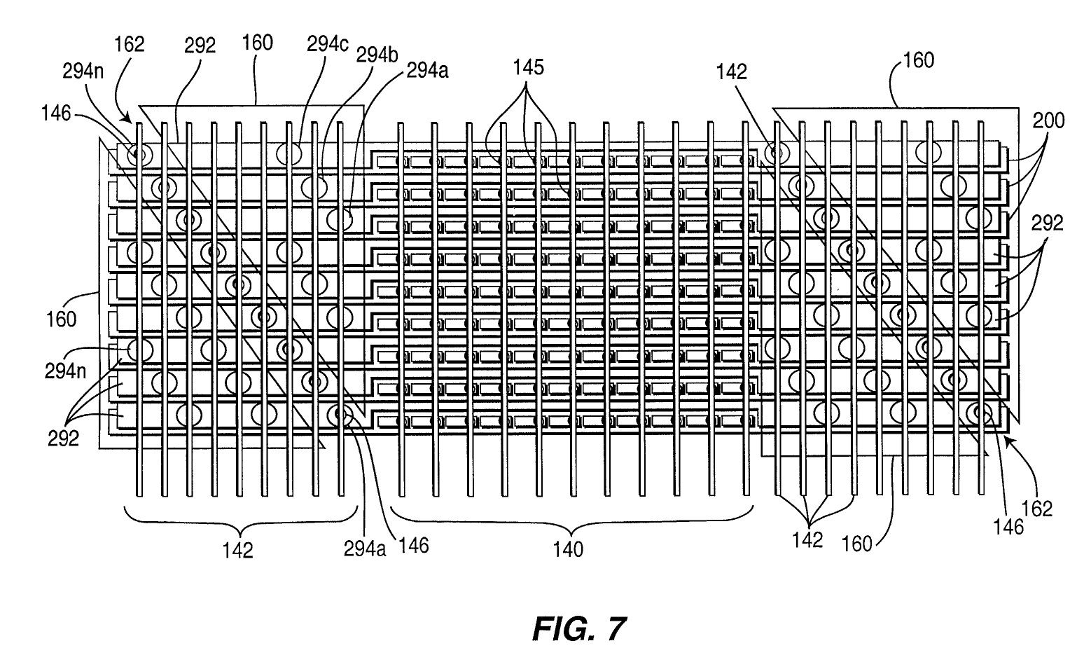

FIG. 6 is a plan view schematic diagram of an exemplary display 10 in accordance with the invention with the circuit module 100 cut away to leave only conductors 140, 142 thereof so as to show connections 145, 146, and FIG. 7 is a plan view schematic diagram of a portion of the display of FIG. 6 enlarged to better show connections 146. Each of image data conductors 140 connects via ones of conductive dots 145 to a corresponding one of the pixel elements 280 of each light-emitting fiber 200, thereby making the “column” or “data” connections to the plurality of fibers 200 of display 10. Because conductors 140 are substantially parallel to each other and transverse to the length of fibers 200, only the tolerance in the direction along the length of fibers 200 need be of concern in placing and connecting circuit board 100.

Similarly, each of select conductors 142 connects via one of conductive dots 146 to a corresponding one of the contacts 294a-294g of a selected one of light-emitting fibers 200, thereby making the “row” or “select” connections to the plurality of fibers 200 of display 10. Because select contacts 294a-294g are on the same surface of fibers 200 as are data contacts 270, 272, and because conductors 142 are substantially parallel and transverse to the length of fibers 200, as are conductors 140, only the tolerance in the direction along the length of fibers 200 need be of concern in placing and connecting circuit board 100.

As a result, only the tolerance in one dimension need be controlled in assembly, and not the tolerances in two dimensions as where conductors 140 and 142 are orthogonal, thereby facilitating alignment and assembly of display 10. Moreover, because the tolerance needed is eased, the tolerances on the width of each fiber 200 and on the width W of a display 10 may also be eased.

As noted above, the contact area 290 at the end 218 of each fiber 200 is preferably coated with a patterned insulator 292 that has one or more openings defining contacts 294a-294n on each fiber 200 or different contacts on different fibers 200. Preferably, the contact 294 positions are staggered to increase spacing between proximate ones of connections 146, e.g., as illustrated in FIG. 7, or may be staggered for the different color R-G-B fibers 200. For a display 10 having 120 fibers 200 of about 0.25 mm (about 10 mils) width each and having conductors 142 at a pitch of about 0.25 mm (about 10 mils), the connection area at the ends of fibers 200 would be about 30.05 mm (about 1.20 inches), and the placement tolerance for connections 146 may increase from about ±¼ fiber width to about ±2 fiber widths.

Maintaining placement tolerance for connections 145, 146 over the length of fibers 200 is not seen to materially change due to the additional length of about 30 mm (about 1.2 inches) at one or both ends of fiber 200. For a typical HDTV display having an about 168 cm (about 66 inch) screen diagonal and a 16:9 aspect ratio, the length of vertically disposed fibers 200 containing light-emitting elements 280 is about 86 cm (about 34 inches), and so an added length of about 3 cm (about 1.2 inches) at one or both ends of fiber 200 is not material placement tolerances.

Alternatively, and/or additionally, a patterned insulator could be applied over conductors 142 of circuit board 100, as shown in the alternative arrangement of FIG. 7, to the same end of exposing only the areas of conductors 142 to which connections 146 would connect. A pair of triangular-shaped sheets 160 of insulating material are placed at each end of the side-by-side array of fibers 200. The triangular insulators 160 are placed hypotenuse-to-hypotenuse but slightly apart to define a diagonal channel 162 so that a set of contacts 294a, . . . , 294n disposed in diagonal channel 162 are exposed for connection via connections 146 to conductors 142 of circuit board 100. Insulating sheets 160 are disposed between the array of fibers 200 and conductors 142 of circuit board 100, and may or may not be attached to one or both of them.

Also alternatively, plural conductors 142 may make plural connections 146 to the select conductor 290 of a particular fiber 200, as may be convenient for increasing the current-carrying capacity and/or the reliability thereof, such as by providing connection thereto at both ends of each fiber 200, as shown in FIG. 7. Further, conductors 142 could be segmented so as to either double the number of connections that can be made in a given end-length dimension of fibers 200 or to increase the spacing between adjacent conductors 142. The foregoing could be utilized to decrease the number of different arrangements for contacts 294a-294n needed for fibers 200 where each fiber has only one of contacts 294a-294n exposed through insulator 292.

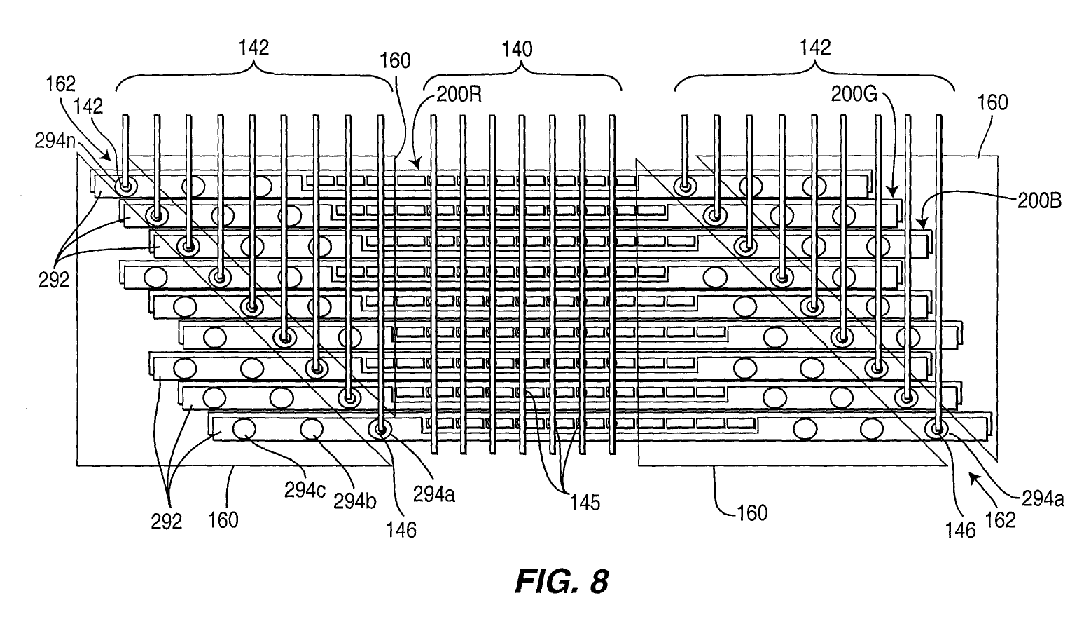

FIG. 8 is a plan view schematic diagram of an alternative arrangement of the display 10 of FIG. 7 wherein light-emitting fibers 200R, 200G, 200B producing red, green and blue light, respectively, are offset longitudinally by the spacing of 1 or 2 pixels, respectively. I.e. fibers 200R, 200G, 200B producing light of different colors are disposed in staggered longitudinal relationship. Respective contacts 294a-294n of fibers 200R, 200G, 200B are likewise staggered and connect to respective conductors 142 of circuit board 100 via connections 146 in like manner to that described above. Triangular insulation sheets 160 may be employed, as above.

One benefit of the arrangement of FIG. 8 is that fewer different patterns of contacts 294 are required in insulation layer 292, thereby simplifying the processing of fibers 200R, 200G, 200B. As shown, the pattern of contacts 294a-294n of fibers 200R, 200G, 200B is the same, and additional contact spacing inures from the longitudinal offsetting of the relative positions of fibers 200R, 200G, 200B. This benefit is available for both color and monochrome displays.

For the about 168 cm (about 66 inch) screen diagonal 16:9 aspect ratio HDTV display described above, a longitudinal offset of about 0.75 mm (about 0.030 inch) for each of the 120 fibers 200 would produce an added length of about 9 cm (about 3.6 inches) at one or both ends of fiber 200 as compared to the 86-cm (about 34-inch) length of vertically disposed fibers 200 containing light-emitting elements 280.

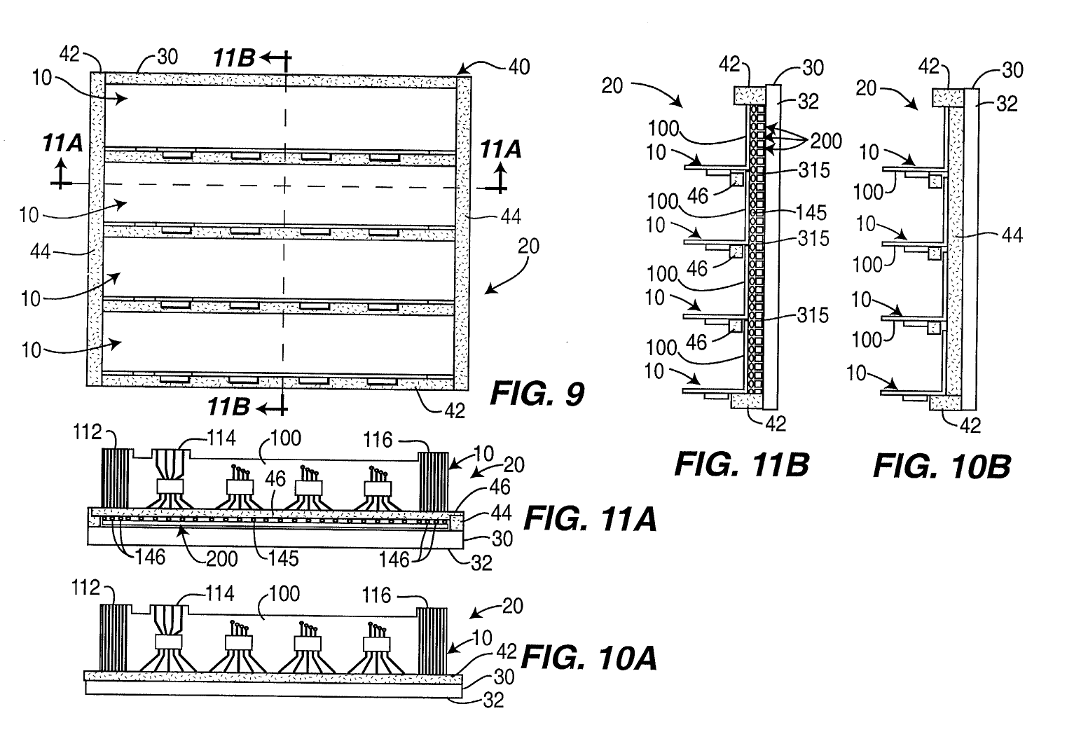

While a light-emitting display may be provided by one display 10 as thus far described, it is desirable to employ a plurality of displays 10 as display modules 10 to provide a larger light-emitting display. FIG. 9 is a rear plan view schematic diagram of an exemplary light-emitting display 20 including a plurality of the display modules 10 of FIGS. 2A through 2C. FIG. 9 is described below in conjunction with FIGS. 10A and 10B which are a side view and an end view schematic diagram, respectively, of the exemplary light-emitting display of FIG. 9, and in conjunction with FIGS. 11A and 11B which are cross-sectional views taken along cross-section lines 11A-11A and 11B-11B, respectively, in FIG. 9.

Display 20 is typically a planar panel comprising a plurality of display modules 10 with the light-emitting surface 202 of light-emitting fibers 200 mounted to a planar faceplate 30, such as a sheet of glass or transparent plastic, having a surface defining a viewing surface 32 at which a viewer can perceive the information displayed on display 20. The modules 10 may be mounted by adhesively attaching the fibers 200 of modules 100 to faceplate 30, such as by an optically transparent adhesive having an index of refraction suitably matched to the indices of refraction of the fibers 200 and faceplate 30. Alternatively, modules 10 may be mounted with the light-emitting surfaces 202 of fibers 200 spaced away from faceplate 30.

Adjacent modules 10 may be insulated from each other by a thin insulating spacer or shim (not visible) that prevents contacts or other electrical conductors of the end light-emitting fibers 200 that abut each other to not short circuit. The spacer may be a sheet of Mylar or other plastic, e.g. about ¼ to ½ mil (about 6-13 μm) thick, or may be provided by an insulating layer deposited on at least the ones of fibers 200 that are at the edge on module 10 or by embossed spacers 315 spacing away the edge of the end ones of fibers 200 in each module 10.

Modules 10 are connected to each other and to other apparatus (not shown), such as an RF tuner, video processor and drive circuits of a television receiver, or to video processing and drive circuits of a video recorder, video disk player, computer or the like, by ribbon cables or other cables having edge connectors that engage edge connections 112, 114, 116 of circuit boards 100 of modules 10.

Modules 10 are passivated or sealed to faceplate 30 and to each other to prevent or at least retard the entry of moisture into display 20. Peripheral seals 40 around the periphery of faceplate 30 and back seals 46 between modules 10 may be a solid fillet of a single- or two-component sealing material, such as epoxy, silicone, or polyimide. Alternatively, peripheral seal 40 may include plural seals such as edge seals 42 and end seals 44 each formed of a glass strip that is sealed to the adjacent faceplate 30 and module 10 by a thin seal of adhesive, epoxy, silicone or polyimide. An advantage of such glass strip seals is that because the glass is impervious to moisture, the sealant or epoxy is much smaller than for a fillet seal and so presents a smaller cross-sectional area through which moisture can permeate.

The sealing may be made by applying the edge seals 42 and back seals 46, and then applying the end seal 44, Any one or more of these seals, or all of the seals, may be either a fillet of epoxy or other adhesive or the preferred adhesively-attached glass strip seal, or a combination thereof. Dessicant material may be placed within the volume within display 20 sealed by seals 40, 46, preferably in one or more cavities behind faceplate 30 and along one or more edges thereof, for absorbing any residual moisture that may be sealed within the sealed volume of display 20 or that may penetrate seals 40, 46. The sealed volume of display 20 may also be filled with dry gas, such as dry nitrogen or other inert gas, prior to sealing.

While the present invention has been described in terms of the foregoing exemplary embodiments, variations within the scope and spirit of the present invention as defined by the claims following will be apparent to those skilled in the art. For example, the offsetting pattern of contacts 294a-294g may have one repetition in any module, as illustrated, or may have two or more repetitions so as to either accommodate a larger number of fibers 200 or provide increased spacing between adjacent connections 146. In addition, dots of an electrically-insulating adhesive may be placed on fibers 200 in locations not having conductive dots 145, 146, to provide additional strength to the attachment of fibers 200 and circuit board 100.

Other materials and dimensions and layouts of light emitting elements may be utilized in making the light-emitting fibers, display modules and displays according to the invention, as well as the circuit modules and components thereof, the embodiments illustrated being exemplary.

In addition, circuit boards 100 do not have to include electronic devices 150 as shown, but may include only printed wiring for providing direct conductive connections between edge connectors and the contacts of fibers 200. In such arrangement, electronic devices for processing and generating display signals, e.g., select signals and data signals, are located remotely from circuit board 100.

What is claimed is:

1. A display comprising:
a plurality of fibers disposed in side-by-side array and each having a plurality of light-emitting elements disposed on a first surface thereof and a length, each light-emitting element having first and second electrodes,
wherein the first electrodes are electrically connected to a first contact on the first surface proximate an end of each said fiber and wherein the respective second electrodes are connected to respective second contacts proximate the corresponding light-emitting element, and
wherein the respective first contacts of said plurality of side-by-side fibers are at different positions with respect to each other relative to the lengths of the fibers; and
a circuit board having first and second pluralities of elongated conductors disposed in respective substantially parallel side-by-side arrangement,
said circuit board being disposed proximal said plurality of side-by-side fibers with the first and second pluralities of elongated electrical conductors disposed substantially transverse to the lengths of said fibers,
wherein each of the first plurality of elongated conductors is electrically connected to the first contact of a predetermined one of said plurality of fibers and wherein each of the second elongated conductors is electrically connected to the second contacts of corresponding light-emitting elements of each of said plurality of fibers.

2. The display of claim 1 wherein said circuit board includes a substrate having said first and second pluralities of elongated conductors on a first portion thereof and having a second portion thereof angled with respect to the first portion thereof,
wherein the second portion of said circuit board is adapted for receiving electrical signals.

3. The display of claim 2 wherein said circuit board includes at least one of:
at least one electronic device on the second portion thereof coupled to ones of the first and second elongated conductors and connected for receiving the electrical signals, and
connection means on the second portion thereof adapted for receiving the electrical signals and for coupling the electrical signals to predetermined ones of said first and second elongated conductors.

4. The display of claim 1 wherein each of said plurality of fibers further comprises a high-conductivity elongated electrical conductor disposed on a second surface thereof adjacent the first surface thereof for electrically connecting the first electrodes of said plurality of light-emitting elements and said first contact.

5. The display of claim 4 wherein said high-conductivity elongated electrical conductor comprises one of a deposited metal and a strip of metal disposed on the second surface of said fiber.

6. The display of claim 4 wherein at least one of the first and second contacts and said high-conductivity elongated electrical conductor includes at least one of copper, aluminum, chromium, silver, gold, alloys thereof, and combinations thereof.

7. The display of claim 1 further comprising a compressible spacer disposed between adjacent ones of said plurality of fibers,
said compressible spacer including at least one of an electrically insulating material and an electrically conductive material,
said compressible spacer having raised features that are compressible when said plurality of fibers are pressed together in the side-by-side array.

8. The display of claim 7 wherein said raised features include embossing of one of a thin sheet of plastic and of a thin foil of metal.

9. The display of claim 1 wherein at least one of said first contacts are electrically connected to said first elongated conductor, and
wherein said second electrical contacts are electrically connected to said second elongated conductors by at least one of solder, electrically conductive-epoxy and silver-filled epoxy.

10. The display of claim 1 wherein said second contacts include a metal layer deposited on the first surface of said fibers proximate the end thereof.

11. The display of claim 10 further comprising at least one of:
an insulating layer deposited on said metal layer and having an opening therein defining the first contact of said fiber, and
a pair of triangular insulators disposed between said plurality of fibers and said circuit board proximate said first plurality of elongated conductors.

12. The display of claim 1 wherein ones of the plurality of light-emitting fibers emit light of different colors and are disposed in staggered longitudinal relationship.

13. A set of light-emitting fibers comprising:
a plurality of lengths of elongated fiber each having a plurality of light-emitting elements disposed on a first surface thereof, each light-emitting element having first and second electrodes,
wherein the first electrodes of the light-emitting elements of each said elongated fiber are electrically connected to a first contact on the first surface proximate an end of that fiber, and
wherein the respective second electrodes are connected to respective second contacts proximate the corresponding light-emitting element,
wherein the respective first contact of each light-emitting fiber is at a different position relative to the length of the light-emitting fibers than are the first contacts of other ones of the set of light-emitting fibers.

14. The set of light-emitting fibers of claim 13 further comprising:
an electrically conductive area on the first surface of each of said set of light-emitting fibers, and
a patterned insulating layer disposed on said electrically conductive area,
said patterned insulating layer having at least one opening therein defining said first contact.

15. The set of light-emitting fibers of claim 13 further comprising:
an elongated electrical conductor disposed on a second surface of each fiber adjacent the first surface thereof,
said elongated electrical conductor including at least one of:
a deposited metal and
a strip of metal connecting the first contact thereof to an electrode of each light-emitting element thereof.

16. A display comprising:
a plurality of light-emitting fibers each having a given number of light-emitting elements along a first surface thereof at a first pitch, each light-emitting element having a first contact associated therewith,
wherein said plurality of light-emitting fibers are disposed side-by-side one another with corresponding ones of the first contacts thereof substantially aligned in a direction transverse to the light-emitting fiber,
whereby second surfaces opposite the first surfaces thereof define a viewing surface for the display;
a second contact on the first surface of each of the plurality of light-emitting fibers and connected to the light-emitting elements thereof,
wherein said second contacts of the plurality of light-emitting fibers are spaced away from an end one of the given number of light-emitting elements by different multiples of a second pitch;
a circuit having first and second substantially parallel conductors spaced-apart respectively at the first and second pitches on a surface thereof disposed proximate the first surfaces of said plurality of light-emitting fibers and substantially transverse thereto; and
means electrically connecting each of the first substantially parallel conductors to corresponding ones of the first contacts of said plurality of light-emitting fibers and connecting one of the second substantially parallel conductors to the second contact of a corresponding one of said plurality of light-emitting fibers.

17. The display of claim 16 wherein each of said plurality of light-emitting fibers further comprises a high-conductivity elongated electrical conductor disposed on a second surface thereof adjacent the first surface thereof for electrically connecting said plurality of light-emitting elements and said second contact.

18. The display of claim 17 wherein said high-conductivity elongated electrical conductor comprises one of a deposited metal and a strip of metal disposed on the second surface of said fiber.

19. The display of claim 16 further comprising:
a compressible spacer disposed between adjacent ones of said plurality of light-emitting fibers,
said compressible spacer including at least one of an electrically insulating material and an electrically conductive material,
said compressible spacer having raised features that are compressible when said plurality of fibers are pressed together in the side-by-side array.

20. The display of claim 19 wherein said raised features include embossing of one of a thin sheet of plastic and of a thin foil of metal.

21. The display of claim 16 further comprising:
a transparent faceplate disposed proximate second surfaces of said light-emitting fibers opposite the first surfaces thereof,
wherein the second surfaces of said plurality of light-emitting fibers are one of attached to said faceplate and spaced apart from said faceplate.

22. The display of claim 16 wherein said circuit includes at least one electronic device and connection means adapted for receiving electrical signal and for coupling said electrical signal to at least one of said first and second substantially parallel conductors and said electronic device.

23. A display comprising a plurality of display modules in side-by-side abutting relationship, each said display module comprising:
a plurality of fibers disposed in side-by-side array and each having a plurality of light-emitting elements disposed on a first surface thereof and a length, each light-emitting element having first and second electrodes,
wherein the first electrodes are electrically connected to a first contact on the first surface proximate an end of each said fiber,
wherein the respective second electrodes are connected to respective second contacts proximate the corresponding light-emitting element,
wherein the respective first contacts of said plurality of side-by-side fibers are at different positions with respect to each other relative to the lengths of the fibers; and
a circuit board having first and second pluralities of elongated conductors disposed in respective substantially parallel side-by-side arrangement,
said circuit board being disposed proximal said plurality of side-by-side fibers with the first and second pluralities of elongated electrical conductors disposed substantially transverse to the lengths of said fibers,
wherein each of the first plurality of elongated conductors is electrically connected to the first contact of a predetermined one of said plurality of fibers, and
wherein each of the second elongated conductors is electrically connected to the second contacts of corresponding light-emitting elements of each of said plurality of fibers; and
means adapted to couple the circuit board of each said display module to a source of electrical signals.

24. The display of claim 23 further comprising:
a transparent faceplate,
wherein said plurality of display modules are disposed side-by-side one another with second surfaces of said light-emitting fibers opposite the first surfaces thereof proximate said faceplate,
wherein the second surfaces of said plurality of light-emitting fibers are one of attached to said faceplate and spaced apart from said faceplate.

25. The display of claim 23 further comprising:
a compressible spacer disposed between adjacent ones of said plurality of display modules,
said compressible spacer including at least one of an electrically insulating material and an electrically conductive material,
said compressible spacer having raised features that are compressible when said plurality of fibers are pressed together in the side-by-side abutting relationship.

26. A display comprising:
a transparent faceplate;
a plurality of display modules in side-by-side abutting relationship on said faceplate; each said display module comprising:
a plurality of light-emitting fibers each having a given number of light-emitting elements along a first surface thereof at a first pitch, each light-emitting element having a first contact associated therewith,
wherein said plurality of light-emitting fibers are disposed side-by-side one another with corresponding ones of the first contacts thereof substantially aligned in a direction transverse to the lightemitting fiber,
whereby second surfaces opposite the first surfaces thereof are proximate said faceplate for defining a viewing surface for the display;
a second contact on the first surface of each of the plurality of light-emitting fibers and connected to the light-emitting elements thereof,
wherein said second contacts of the plurality of light-emitting fibers are spaced away from an end one of the given number of light-emitting elements by different multiples of a second pitch;
a circuit having first and second substantially parallel conductors spaced-apart respectively at the first and second pitches on a surface thereof disposed proximate the first surfaces of said plurality of light-emitting fibers and substantially transverse thereto; and
an electronic device on said circuit board and coupled to said at least one elongated electrical conductor for applying an electrical signal thereto; and
means electrically connecting each of the first substantially parallel conductors to corresponding ones of the first contacts of said plurality of light-emitting fibers and connecting one of the second substantially parallel conductors to the second contact of a corresponding one of said plurality of light-emitting fibers.

27. A method for making a light-emitting display comprising:
placing side-by-side one another a plurality of elongated light-emitting fibers each having a plurality of light-emitting elements disposed along a first surface thereof and having a second surface opposite the first surface thereof for providing a viewing surface for the display, each light-emitting fiber having a first contact on the first surface thereof connected to first electrodes of the light-emitting elements thereon and each light-emitting element having a second contact connected to a second electrode thereof;
providing a circuit substrate having first and second sets of substantially parallel elongated electrical conductors on one surface thereof;
placing the one surface of the circuit substrate and the first surfaces of the side-by-side plurality of elongated fibers proximate one another;
electrically connecting ones of the first set of elongated electrical conductors to the first contact of a respective one of the light-emitting fibers; and
electrically connecting ones of the second set of elongated electrical conductors to the exposed contacts on each of said plurality of light-emitting fibers.

28. The method of claim 27 wherein at least one of said electrically connecting ones of the first set and said electrically connecting ones of the second set includes:
applying an electrically conductive connection material on at least one of the first and second contacts on each of said plurality of light-emitting fibers and the first and second sets of elongated electrical conductors, and
wherein said placing includes the first and second contacts and the first and second sets of elongated conductors coming into contact with the electrically conductive connection material.

29. A method of assembling a plurality of linear fibers into a two dimensional array having a given width comprising:
placing the plurality of fibers side by side in two dimensional array;
placing a linear compressible element between adjacent ones of the fibers side by side therewith in the two dimensional array; and
compressing the fibers and the compressible elements in a direction transverse to their linear dimension until the array has the given width.

30. A module of linear light-emitting fibers in side by side array, each fiber having a plurality of first contacts along an exposed side thereof and having a second contact extending along a length thereof, wherein the first and second contacts are coupled to a plurality of light-emitting elements disposed along the exposed side of each linear light-emitting fiber, comprising:
a plurality of first linear conductors transverse to the length of the light-emitting fibers, each transverse first conductor connecting together respective ones of the first contacts of the light-emitting fibers that are in a given position along the length of each light-emitting fiber;
an insulator overlying the light-emitting fibers at least near one portion thereof and having one or more openings therein to expose in different lineal and transverse positions ones of the second contact of each light-emitting fiber; and
a plurality of second linear conductors transverse to the length of the light-emitting fibers, each transverse second conductor connecting to a respective second contact of one of the light-emitting fibers that are in a given lineal and transverse position.
